(19) United States
(12) Patent Application Publication
(10) Pub. No.: US 2019/0179130 A1
(43) Pub. Date: Jun. 13, 2019

(54) SIMULTANEOUS MULTI-MAGNIFICATION REFLECTIVE TELESCOPE UTILIZING A SHARED PRIMARY MIRROR

(71) Applicant: RAYTHEON COMPANY, Waltham, MA (US)

(72) Inventors: Kirk A. Miller, Dallas, TX (US); Douglas J. Hartnett, The Colony, TX (US)

(21) Appl. No.: 15/835,032

(22) Filed: Dec. 7, 2017

(51) Int. Cl. G02B 23/06; G02B 15/12; G02B 23/14

(52) U.S. Cl. CPC G02B 23/06; G02B 23/14; G02B 15/12

(57) ABSTRACT

A multi-magnification reflective telescope of an optical system includes a case, a shared primary mirror coupled to the case, and a secondary mirror coupled to the case. The shared primary mirror is configured to expand a beam of electromagnetic radiation and the secondary mirror is configured to direct the beam of electromagnetic radiation to and to receive the target image from the shared primary mirror. The multi-magnification reflective telescope is configured to simultaneously direct the beam of electromagnetic radiation along a laser output path toward a target and to receive a target image along an imaging optical path and to direct the target image to one or more detectors simultaneously.

### BACKGROUND OF THE INVENTION

Modern tactical aircraft use a number of imaging aids to assist the crew in viewing a scene, selecting targets in the scene, and directing weapons against the selected targets. Visible, infrared, and/or specific spectral bands imaging devices are used in various applications to form an image of the scene. The type of imaging spectrum depends upon the mission, weather conditions, the nature of the scene, as well as other factors.

One form of an optical system includes several lenses having varying magnification. The lenses are arranged at proper positions by a positioning mechanism along an optical path to achieve desired effects by a lens mount assembly. It is critical that the lenses be properly aligned by the mechanism, which often is difficult to access to adjust the lenses. There is presently a need for an optical system including a reflective telescope that has at least two simultaneous magnifications, one magnification for the purpose of imaging incoming light and one or two magnifications for outgoing light, such as a pulsed laser and/or a continuous wave illuminating laser without having the laser pass through an intermediate image plane.

There are two known approaches to provide simultaneous magnifications within the optical system. One approach includes coaxial systems having an imaging system and a laser system that uses the same telescope optics at the expense of lowered optical transmission in both imaging and laser modes. Another approach includes separate aperture systems with dedicated apertures for each function, on an embedded system that causes field of view issues due to aperture separation.

### SUMMARY OF INVENTION

One aspect of the present disclosure is directed to an optical system comprising a housing and a laser coupled to the housing. The laser is configured to generate a beam of electromagnetic radiation. The optical system further comprises a multi-magnification reflective telescope coupled to the housing. The multi-magnification reflective telescope is configured to simultaneously direct the beam of electromagnetic radiation along a laser output path toward a target and to receive a reflected target image along an imaging optical path. The optical system further comprises one or more detectors coupled to the housing. Each detector is configured to selectively receive the target image from the multi-magnification reflective telescope.

Embodiments of the optical system further may include configuring the housing to have a window through which the beam of electromagnetic radiation travels toward the target and through which the target image is received. The one or more detectors may include a mid-wave infrared (MWIR) camera, a short-wave infrared (SWIR) camera and a day television (DTV). The multi-magnification reflective telescope includes a case, a shared primary mirror coupled to the case, and a secondary mirror coupled to the case. The shared primary mirror may be configured to expand the beam of electromagnetic radiation and the secondary mirror may be configured to direct the beam of electromagnetic radiation to and to receive the target image from the shared primary mirror. The multi-magnification reflective telescope further may include an eyepiece and a beam splitter coupled to the case, the eyepiece and the beam splitter being configured to direct the beam of electromagnetic radiation from the laser to the secondary mirror. The eyepiece may be selected to increase a magnification of the beam of electromagnetic radiation from 9× to 20×. The multi-magnification reflective telescope further may include a tertiary mirror coupled to the case, with the tertiary mirror being configured to direct the target image from the secondary mirror and the beam splitter. The tertiary mirror may be selected to increase a magnification of the target image up to 12× magnification. The multi-magnification reflective telescope further may include a fast steering mirror coupled to the case, the fast steering mirror being configured to direct the target image from the tertiary mirror to one or more detectors simultaneously.

Another aspect of the disclosure is directed to a method of simultaneously generating a beam of electromagnetic radiation and receiving a reflected target image. In one embodiment, the method comprises: generating a beam of electromagnetic radiation; directing the beam of electromagnetic radiation along a laser output path toward a target; receiving a target image; and directing the target image along an imaging optical path to one or more detectors simultaneously, the directing the target image being achieved simultaneously with the directing the beam of electromagnetic radiation.

Embodiments of the method further may include one or more detectors having a mid-wave infrared (MWIR) camera, a short-wave infrared (SWIR) camera and a day television (DTV). Directing the electromagnetic radiation and directing the target image may be achieved by way of a multi-magnification reflective telescope including a case, a shared primary mirror coupled to the case, and a secondary mirror coupled to the case. The shared primary mirror may be configured to expand the beam of electromagnetic radiation and the secondary mirror may be configured to direct the beam of electromagnetic radiation to and to receive the target image from the shared primary mirror. The multi-magnification reflective telescope further may include an eyepiece and a beam splitter coupled to the case, with the eyepiece and the beam splitter being configured to direct the beam of electromagnetic radiation from the laser to the secondary mirror. The multi-magnification reflective telescope further may include a tertiary mirror coupled to the case, with the tertiary mirror being configured to direct the target image from the secondary mirror and the beam splitter. The multi-magnification reflective telescope further may include a fast steering mirror coupled to the case, with the fast steering mirror being configured to direct the target image from the tertiary mirror to one or more detectors simultaneously.

Yet another aspect of the disclosure is directed to a multi-magnification reflective telescope of an optical system. In one embodiment, the reflective telescope comprises a case, a shared primary mirror coupled to the case, and a secondary mirror coupled to the case. The shared primary mirror is configured to expand a beam of electromagnetic radiation and the secondary mirror is configured to direct the beam of electromagnetic radiation to and to receive a reflected target image from the shared primary mirror. The multi-magnification reflective telescope is configured to simultaneously direct the beam of electromagnetic radiation along a laser output path toward a target and to receive a target image along an imaging optical path and to direct the target image to at least one of one or more detectors.

Embodiments of the multi-magnification reflective telescope further may include an eyepiece and a beam splitter coupled to the case, the eyepiece and the beam splitter being configured to direct the beam of electromagnetic radiation from the laser to the secondary mirror. The multi-magnification reflective telescope further may include a tertiary mirror coupled to the case, with the tertiary mirror being configured to direct the target image from the secondary mirror and the beam splitter. The multi-magnification reflective telescope further may include a fast steering mirror coupled to the case, with the fast steering mirror being configured to direct the target image from the tertiary mirror to at least one of the one or more detectors. The eyepiece may be selected to increase a magnification of the beam of electromagnetic radiation from 9× to 20×, and the tertiary mirror may be selected to increase a magnification of the target image up to 12× magnification.

### BRIEF DESCRIPTION OF THE DRAWINGS

Various aspects of at least one embodiment are discussed below with reference to the accompanying figures, which are not intended to be drawn to scale. Where technical features in the figures, detailed description or any claim are followed by references signs, the reference signs have been included for the sole purpose of increasing the intelligibility of the figures, detailed description, and claims. Accordingly, neither the reference signs nor their absence are intended to have any limiting effect on the scope of any claim elements. In the figures, each identical or nearly identical component that is illustrated in various figures is represented by a like numeral. For purposes of clarity, not every component may be labeled in every figure. The figures are provided for the purposes of illustration and explanation and are not intended as a definition of the limits of the invention. In the figures:

FIG. 1 is a schematic block diagram of a simultaneous multi-magnification reflective telescope utilizing a shared primary mirror of an embodiment of the present disclosure;

FIG. 2 is a cross-sectional elevational view of the multi-magnification reflective telescope revealing components of the reflective telescope;

FIG. 3 is a cross-sectional perspective view of the multi-magnification reflective telescope revealing components of the reflective telescope;

FIG. 4 is a cross-sectional elevational view of the multi-magnification reflective telescope showing a ray trace of a laser output path and a ray trace of an imaging optical path;

FIG. 5 is a ray trace of an imaging optical path and using 12× imaging with a 2.5× laser; and

FIG. 6 is a ray trace of an imaging optical path and a laser output path using 10× imaging with a 4× laser.

### DETAILED DESCRIPTION OF THE INVENTION

Embodiments of the present disclosure are directed to simultaneous multi-magnification reflective telescope that utilizes a shared primary mirror. In one embodiment, the multi-magnification reflective telescope includes an additional refractive eyepiece and/or secondary mirror, which is added to a three mirror anastigmat design. An anastigmat lens is a compound lens corrected for the aberrations of astigmatism and curvature of field. Light is folded into the additional secondary mirror or refractive eyepiece forming a Galilean telescope, which does not have an intermediate image. The secondary telescopes have either a much smaller or larger magnification ratio than the original telescope. Refractive eyepiece designs have higher magnification and can simultaneously use the shared primary mirror with the imaging optics. Additional secondary designs have a lower magnification and obscure a portion of the secondary mirror from imaging optical use. The telescope is intended to be simultaneously used with the anastigmat telescope.

The phraseology and terminology used herein is for the purpose of description and should not be regarded as limiting. Any references to embodiments or elements or acts of the systems and methods herein referred to in the singular may also embrace embodiments including a plurality of these elements, and any references in plural to any embodiment or element or act herein may also embrace embodiments including only a single element. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. Any references to front and back, left and right, top and bottom, upper and lower, and vertical and horizontal are intended for convenience of description, not to limit the present systems and methods or their components to any one positional or spatial orientation.

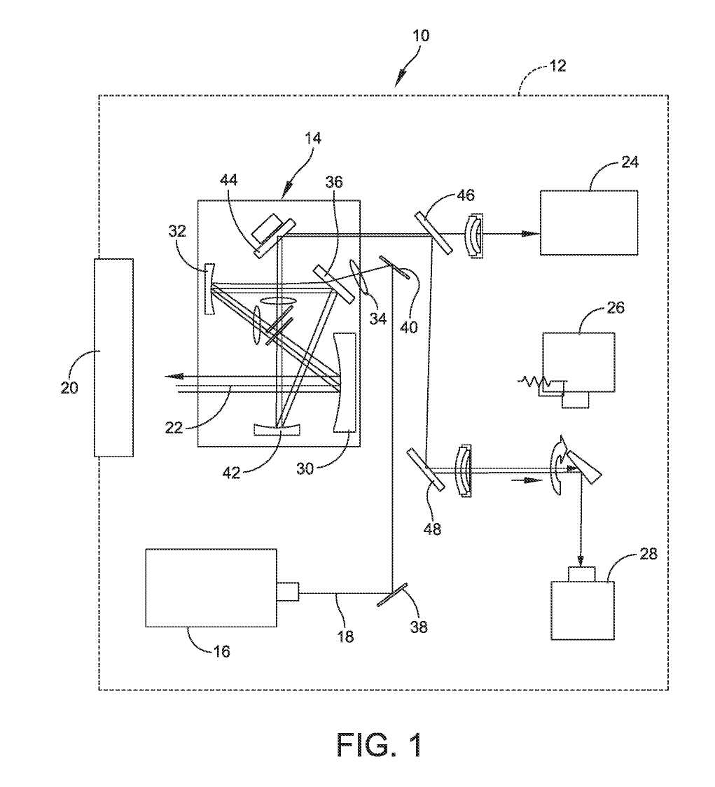

Referring to the drawings, and more particularly to FIG. 1, an optical system is generally indicated at 10. In one embodiment, the optical system 10 includes a housing 12 configured to contain and mount components of the optical system 10. The optical system 10 further includes a simultaneous multi-magnification reflective telescope, generally indicated at 14, coupled to the housing 12. The multi-magnification reflective telescope 14 utilizes a shared primary mirror that will be described in greater detail below. As shown, the optical system 10 further includes a laser 16 coupled to the housing 12. The laser 16 is configured to generate a beam 18 of electromagnetic radiation to the multi-magnification reflective telescope 14 along a laser output path. The optical system 10 further includes a window 20 provided in the housing 12 through which the beam 18 of electromagnetic radiation travels during operation. Optical images travel back through the window 20 of the housing 12 in the form of a reflected target image 22 along an imaging optical path through the multi-magnification reflective telescope 14. This target image 22 may be delivered to one of several detectors provided in the optical system 10, including but not limited to a mid-wave infrared (MWIR) camera 24, a short-wave infrared (SWIR) camera 26 and a day television (DTV) 28.

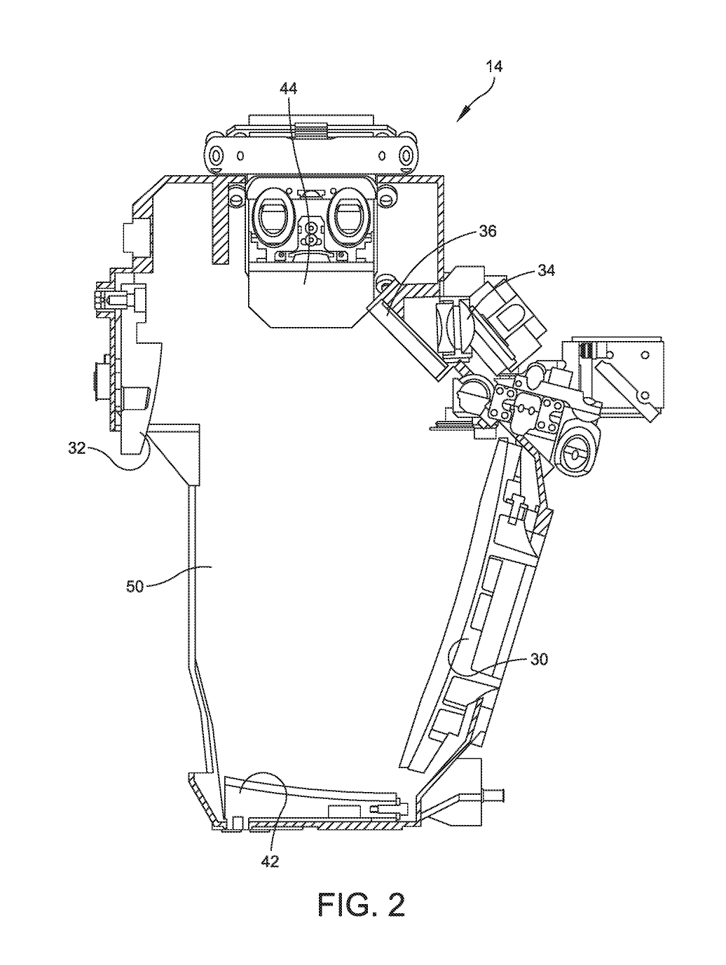

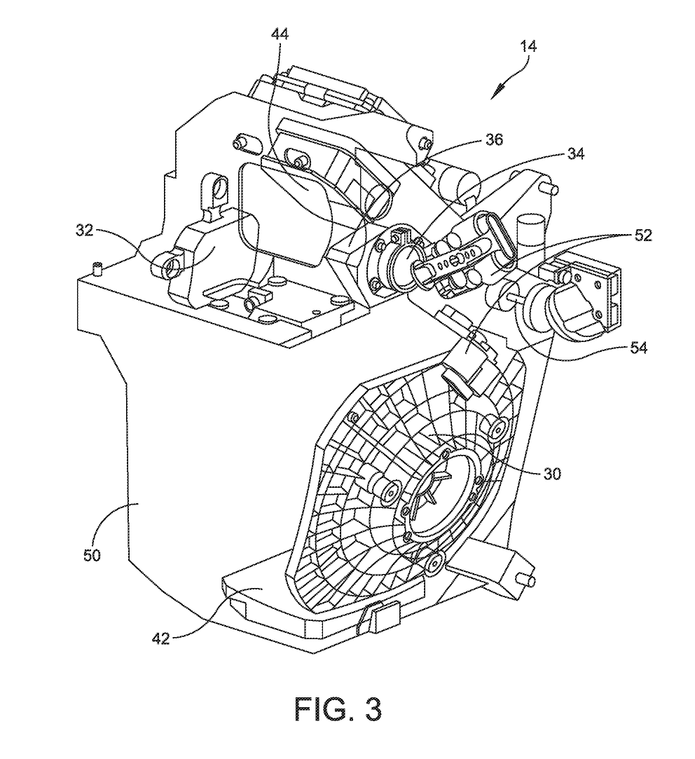

As will be discussed in greater detail below with reference to FIGS. 2 and 3, the multi-magnification reflective telescope 14 includes a shared primary mirror 30 that is configured to expand the beam 18 of electromagnetic radiation prior to exiting the window 20 of the housing 12. The multi-magnification reflective telescope 14 further includes a secondary mirror 32 that is configured to direct the beam 18 of electromagnetic radiation to and to receive the target image 22 from the shared primary mirror 30. The multi-magnification reflective telescope 14 further includes an eyepiece 34 and a beam splitter 36, which are configured to direct the beam 18 of electromagnetic radiation from the laser via mirrors 38, 40 to the secondary mirror 32. The eyepiece 34 is selected to increase a magnification of the beam 18 of electromagnetic radiation anywhere from 9× to 20× based on the layout design of the shared primary mirror 30 and the secondary mirror 32. In one embodiment, the eyepiece 34 is configured to magnify the beam of electromagnetic radiation 12×.

The beam splitter 36 further is configured to direct the target image 22 from the secondary mirror 32 to a tertiary mirror 42 of the multi-magnification reflective telescope 14. The multi-magnification reflective telescope 14 further includes a multi-axis fast steering mirror 44 that is configured to direct the target image 22 from the tertiary mirror 42 to the detectors, e.g., MWIR camera 24, SWIR camera 26 and DTV 28, via beam splitter 46 and mirror 48. Although the multi-axis fast steering mirror 44 of the multi-magnification reflective telescope 14 in the shown embodiment is configured to direct the target image 22 to one of the three shown detectors, it should be understood that the optical system 10 can be configured to accommodate any number of detectors. Also, the multi-axis fast steering mirror 44 of the multi-magnification reflective telescope 14 can be configured to vary the direction of the target image 22 based on the positions of detectors with respect to the multi-axis fast steering mirror 44.

Referring to FIGS. 2 and 3, the components of the multi-magnification reflective telescope 14 are secured in a case or housing 50 that embodies a compact imaging and illuminating system (CIIS). In one embodiment, the compact CIIS provides detailed intelligence data from the visual and infrared spectrum in support of military and civilian operations. The compact CIIS can be configured to provide long-range surveillance, target acquisition, tracking, range finding and laser designation.

As shown, the case 50 is formed and configured to support the shared primary mirror 30, the secondary mirror 32 and the tertiary mirror 42 in secure positions during operation. In one embodiment, the case 50 is fabricated from a suitable metal material, such as an aluminum alloy having the same coefficient of thermal expansion as the primary mirror 30, secondary mirror 32 and tertiary mirror 42. As shown, the shared primary mirror 30 is secured or coupled to the case 50 at an angle so that it receives the beam 18 of electromagnetic radiation along the laser output path from the secondary mirror 32 and directs the beam of electromagnetic radiation to the window 20 of the housing 12 (FIG. 1). As mentioned above, the shared primary mirror 30 is configured to expand the beam 18 of electromagnetic radiation. The secondary mirror 32 is secured or coupled to the case 50 in a position across from the shared primary mirror 30, the eyepiece 34 and the beam splitter 36, each of which is also coupled to the case 50. As described above, the eyepiece 34 may be selected based on the layout of the shared primary mirror 30 and the secondary mirror 32 to achieve a desired magnification of multi-magnification reflective telescope 14. The tertiary mirror 42 is mounted on or coupled to the case 50 at a bottom of the case. The tertiary mirror 42 is used by the imaging detectors only, and can provide magnification of the target image 22, e.g., magnification ranging from 3× to 12×.

FIG. 3 illustrates the multi-magnification reflective telescope 14 including single axis fast steering mirrors 52 disposed before the eyepiece 34 and coupled to the case 50. Embodiments of each fast steering mirror of the single axis fast steering mirrors 52 may include a reflective surface, and may be configured to manipulate the reflective surface to control the direction of the reflection of the beam 18 of electromagnetic radiation produced by the laser off of the reflective surface. Each single axis fast steering mirror further may include a fixed base, a pivot flexure or bearing, which couples the reflective surface to the base, and several actuators each configured to move the reflective surface relative to the base. Each single axis fast steering mirror may be configured to manipulate the reflective surface to control a direction of the reflection of the beam of electromagnetic radiation, including light and infrared light, off of the reflective surface, and configured to steer the reflective surface as a unit.

The multi-magnification reflective telescope 14 further may include beam reducer optics 54 disposed before the single axis fast steering mirrors 52. The beam reducer optics 54 is provided to fit the beam 18 of electromagnetic radiation generated by the laser 16 into a controlled laser beam.

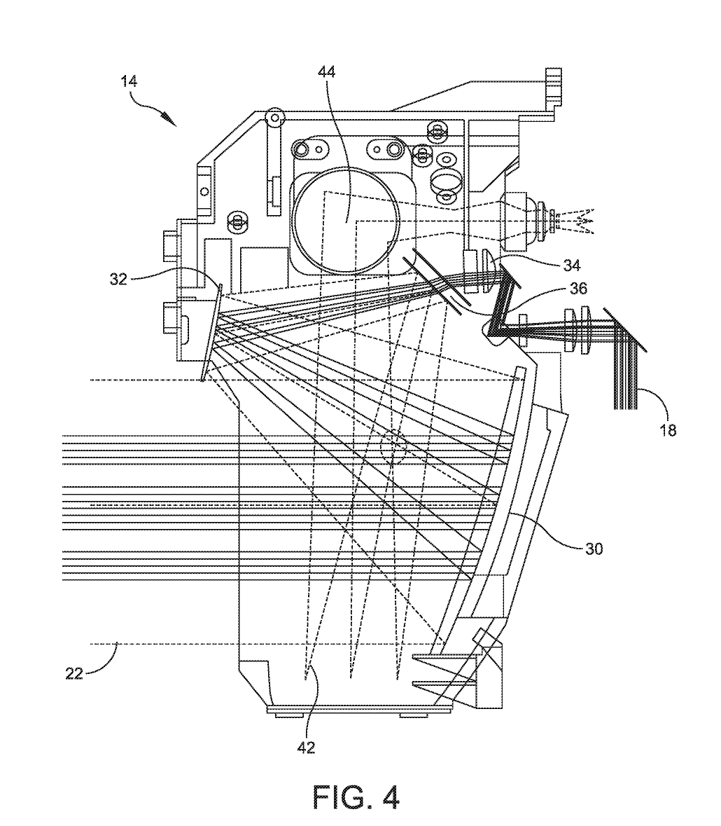

Referring to FIG. 4, a trace pattern of the beam 18 of electromagnetic radiation along the laser output path is represented by solid lines, and a trace pattern of the target image 22 along the imaging optical path is represented by dashed lines. As shown, the beam 18 of electromagnetic radiation generated by the laser 16 enters the multi-magnification reflective telescope 14 via the mirrors 38, 40 shown in FIG. 1. Specifically, electromagnetic radiation enters the multi-magnification reflective telescope 14 through the eyepiece 34 and the beam splitter 36. The eyepiece 34 can be selected to increase the magnification of the laser path output to a desired magnification. The beam 18 of electromagnetic radiation is then directed to the secondary mirror 32, which reflects the beam 18 of electromagnetic radiation to the shared primary mirror 30. The beam 18 of electromagnetic radiation is then directed to the window 20 of the housing 12 of the optical system 10 shown in FIG. 1 toward a field of view target. As the beam 18 of electromagnetic radiation travels along the laser output path within the multi-magnification reflective telescope 14, the laser beam is expanded as it is directed toward the field of view target.

Simultaneously to the transmission of the beam 18 of magnetic radiation along the laser output path, the target image 22 is reflected back to the multi-magnification reflective telescope 14 through the window 20 and toward the shared primary mirror 30. The target image 22 is reflected by the shared primary mirror 30 toward the secondary mirror 32, which in turn directs the target image 22 to the beam splitter 36. The beam splitter 36 directs the target image 22 toward the tertiary mirror 42, which can be selected to increase the magnification of the target image 22. The target image 22 is reflected by the tertiary mirror 42 toward the multi-axis fast steering mirror 44, which in turn directs the target image 22 toward the beam splitter 46 and the mirror 48 (FIG. 1). The target image 22 is then directed to one of the three detectors 24, 26 and 28 by configuring the beam splitter 46 and the mirror 48.

Several case embodiments may be used to house the components of the multi-magnification reflective telescope. For example, one exemplary case may be configured to secure components of an unobscured, free aperture, higher magnification CIIS design. In another example, the case may be configured to secure components of a centrally obscured, free aperture, higher magnification CIIS design.

As referenced above, the tertiary mirror 42 of the multi-magnification reflective telescope 14 may be configured to vary the magnification of the target image 22 directed to the detectors 24, 26 and 28, based on the layout of the shared primary mirror 30 and the secondary mirror 32.

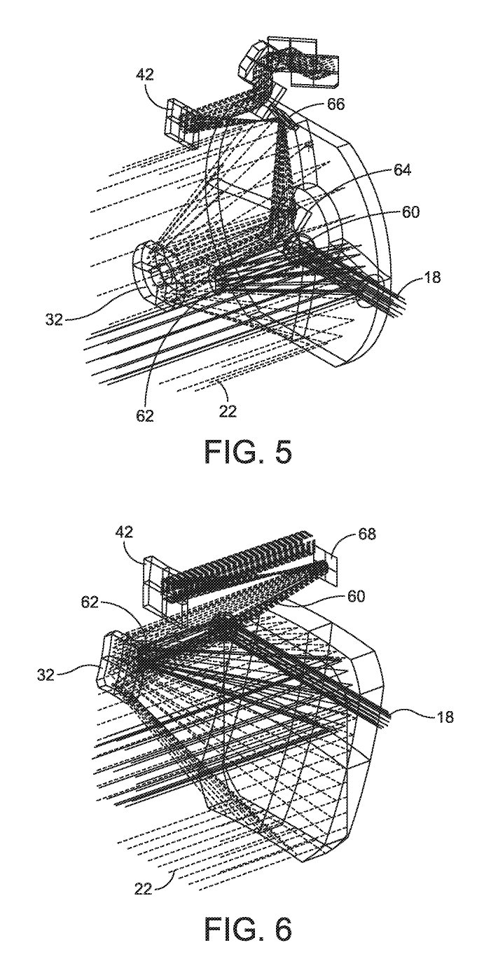

For example, in another embodiment, FIG. 5 illustrates a trace pattern of a beam 18 of electromagnetic radiation along the laser output path that is represented by solid lines in which the beam of electromagnetic radiation is magnified 2.5×. FIG. 5 further illustrates a trace pattern of the target image 22 along the imaging optical path that is represented by dashed lines in which the target image is magnified 12×. In the shown embodiment, the beam 18 of electromagnetic radiation generated by the laser 16 enters the multi-magnification reflective telescope 14 through an insertion mirror 60 and an alternative secondary mirror 62. The beam 18 of electromagnetic radiation is then directed to the shared primary mirror 30, and through the window 20 toward a field of view target. Simultaneously to the transmission of the beam 18 of magnetic radiation along the laser output path, the target image 22 is reflected back to the multi-magnification reflective telescope 14 through the window 20 and toward the shared primary mirror 30. The target image 22 is reflected by the shared primary mirror 30 toward the secondary mirror 32, fold mirrors 64 and 66, and to the tertiary mirror 42. The target image 22 is then reflected toward the multi-axis fast steering mirror 44, the beam splitter 46 and the mirror 48, and ultimately directed to one or more of the three detectors 24, 26, 28.

In another example, FIG. 6 illustrates a trace pattern of a beam 18 of electromagnetic radiation along the laser output path that is represented by solid lines in which the beam of electromagnetic radiation is magnified 4×. FIG. 6 further illustrates a trace pattern of the target image 22 along the imaging optical path that is represented by dashed lines in which the target image is magnified 10×.

A multi-magnification reflective telescope 14 of an optical system 10 may be used to perform a method of simultaneously generating a beam of electromagnetic material and receiving a target image. The method includes generating a beam 18 of electromagnetic radiation with a laser 16. The method further includes directing the beam 18 of electromagnetic radiation along a laser output path toward a target by passing the beam through components of the multi-magnification reflective telescope 14, including, but not limited to an insertion mirror 60, an alternative secondary mirror 62, and a shared primary mirror 30. Next, the method includes receiving a target image 22 by the multi-magnification reflective telescope 14 of the optical system 10, and directing the target image along an imaging optical path to at least one of several detectors, e.g., detectors 24, 26 and 28, via the primary shared mirror 30, the secondary mirror 32, a fold mirror 68, the tertiary mirror 42 and the multi-axis fast steering mirror 44 of the reflective telescope. The directing the target image 22 can be achieved simultaneously with the directing the beam 18 of electromagnetic radiation.

It should be understood that any number of configurations can be achieved, based on the layout of the shared primary mirror 30 and the secondary mirror 32, and the other components of the optical system 10.

Having thus described several aspects of at least one embodiment, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

What is claimed is:

1. An optical system comprising:
a housing;
a laser coupled to the housing, the laser being configured to generate a beam of electromagnetic radiation;
a multi-magnification reflective telescope coupled to the housing, the multi-magnification reflective telescope being configured to simultaneously direct the beam of electromagnetic radiation along a laser output path toward a target and to receive a reflected target image along an imaging optical path; and
one or more detectors coupled to the housing, each detector being configured to selectively receive the target image from the multi-magnification reflective telescope.

2. The optical system of claim 1, wherein the housing includes a window through which the beam of electromagnetic radiation travels toward the target and through which the target image is received.

3. The optical system of claim 1, wherein the one or more detectors include a mid-wave infrared (MWIR) camera, a short-wave infrared (SWIR) camera and a day television (DTV).

4. The optical system of claim 1, wherein the multi-magnification reflective telescope includes
a case,
a shared primary mirror coupled to the case, the shared primary mirror being configured to expand the beam of electromagnetic radiation, and
a secondary mirror coupled to the case, the secondary mirror being configured to direct the beam of electromagnetic radiation to and to receive the target image from the shared primary mirror.

5. The optical system of claim 4, wherein the multi-magnification reflective telescope further includes an eyepiece and a beam splitter coupled to the case, the eyepiece and the beam splitter being configured to direct the beam of electromagnetic radiation from the laser to the secondary mirror.

6. The optical system of claim 5, wherein the eyepiece is selected to increase a magnification of the beam of electromagnetic radiation from 9× to 20×.

7. The optical system of claim 5, wherein the multi-magnification reflective telescope further includes a tertiary mirror coupled to the case, the tertiary mirror being configured to direct the target image from the secondary mirror and the beam splitter.

8. The optical system of claim 8, wherein the tertiary mirror is selected to increase a magnification of the target image up to 12× magnification.

9. The optical system of claim 7, wherein the multi-magnification reflective telescope further includes a fast steering mirror coupled to the case, the fast steering mirror being configured to direct the target image from the tertiary mirror to at least one of the one or more detectors.

10. A method of simultaneously generating a beam of electromagnetic radiation and receiving a reflected target image, the method comprising:
generating a beam of electromagnetic radiation;
directing the beam of electromagnetic radiation along a laser output path toward a target;
receiving a reflected target image; and
directing the target image along an imaging optical path to at least one of one or more detectors, the directing the target image being achieved simultaneously with the directing the beam of electromagnetic radiation.

11. The method of claim 10, wherein the one or more detectors include a mid-wave infrared (MWIR) camera, a short-wave infrared (SWIR) camera and a day television (DTV).

12. The method of claim 10, wherein directing the electromagnetic radiation and directing the target image is achieved by way of a multi-magnification reflective telescope including
a case,
a shared primary mirror coupled to the case, the shared primary mirror being configured to expand the beam of electromagnetic radiation, and
a secondary mirror coupled to the case, the secondary mirror being configured to direct the beam of electromagnetic radiation to and to receive the target image from the shared primary mirror.

13. The method of claim 12, wherein the multi-magnification reflective telescope further includes an eyepiece and a beam splitter coupled to the case, the eyepiece and the beam splitter being configured to direct the beam of electromagnetic radiation from the laser to the secondary mirror.

14. The method of claim 13, wherein the multi-magnification reflective telescope further includes a tertiary mirror coupled to the case, the tertiary mirror being configured to direct the target image from the secondary mirror and the beam splitter.

15. The method of claim 14, wherein the multi-magnification reflective telescope further includes a fast steering mirror coupled to the case, the fast steering mirror being configured to direct the target image from the tertiary mirror to at least one of the one or more detectors.

16. A multi-magnification reflective telescope of an optical system, the reflective telescope comprising:
a case;
a shared primary mirror coupled to the case, the shared primary mirror being configured to expand a beam of electromagnetic radiation; and
a secondary mirror coupled to the case, the secondary mirror being configured to direct the beam of electromagnetic radiation to and to receive a reflected target image from the shared primary mirror,
wherein the multi-magnification reflective telescope is configured to simultaneously direct the beam of electromagnetic radiation along a laser output path toward a target and to receive a reflected target image along an imaging optical path and to direct the target image to at least one of one or more detectors.

17. The reflective telescope of claim 16, further comprising an eyepiece and a beam splitter coupled to the case, the eyepiece and the beam splitter being configured to direct the beam of electromagnetic radiation from the laser to the secondary mirror.

18. The reflective telescope of claim 17, further comprising a tertiary mirror coupled to the case, the tertiary mirror being configured to direct the target image from the secondary mirror and the beam splitter.

19. The reflective telescope of claim 18, further comprising a fast steering mirror coupled to the case, the fast steering mirror being configured to direct the target image from the tertiary mirror to at least one of the one or more detectors.

20. The reflective telescope of claim 18, wherein the eyepiece is selected to increase a magnification of the beam of electromagnetic radiation from 9× to 20×, and wherein the tertiary mirror is selected to increase a magnification of the target image up to 12× magnification.
